(19) United States
(12) Patent Application Publication
(10) Pub. No.: US 2023/0186135 A1
(43) Pub. Date: Jun. 15, 2023

(54) Selective Filtering for Fast Driving of Qubits

(71) Applicant: International Business Machines Corporation, Armonk, NY (US)

(72) Inventors: Muir Kumph, Croton on Hudson, NY (US); Oliver Dial, Yorktown Heights, NY (US); John Blair, Tucson, AZ (US)

(21) Appl. No.: 17/644,424

(22) Filed: Dec. 15, 2021

(51) Int. Cl. G06N 10/40

(52) U.S. Cl. CPC G06N 10/40

(57) ABSTRACT

An apparatus comprising a first qubit has a first driving frequency and a second qubit electrically connected to the first qubit, wherein the second qubit has a second driving frequency, wherein the second driving frequency is different than the first driving frequency. A readout resonator electrically connected to the first qubit and the second qubit and a filter electrically connected to the readout resonator, wherein the filter allows for the first qubit to be driven at the second driving frequency of the second qubit. A drive unit electrically connected to the filter.

### STATEMENT REGARDING FEDERALLY SPONSORED RESEARCH OR DEVELOPMENT

This invention was made with U.S. Government support. The U.S. Government has certain rights in this invention.

### BACKGROUND

The present invention relates to Qubits, and more specifically, to driving Qubits.

Qubits are multi-level quantum systems that can be used for computation. Qubit computation requires applying microwave drive tones to those qubits to enable operations. The magnitude of these tones can be described as the power of the drive tone, in Watts, or as the rate at which a qubit state changes upon the application of the drive tone (Rabi rate), in MHz.

### BRIEF SUMMARY

Additional aspects and/or advantages will be set forth in part in the description which follows and, in part, will be apparent from the description, or may be learned by practice of the invention.

An apparatus comprising a first qubit has a first driving frequency and a second qubit electrically connected to the first qubit, wherein the second qubit has a second driving frequency, wherein the second driving frequency is different than the first driving frequency. A readout resonator electrically connected to the first qubit and the second qubit and a filter electrically connected to the readout resonator, wherein the filter allows for the first qubit to be driven at the second driving frequency of the second qubit. A drive unit electrically connected to the filter.

An apparatus comprising a first qubit has a first driving frequency and a second qubit electrically connected to the first qubit. A readout resonator electrically connected to the first qubit and the second qubit, and a filter electrically connected to the readout resonator, wherein the filter allows for the first qubit to be driven at a drive frequency that is different from the first driving frequency. A drive unit electrically connected to the filter.

A method comprising applying a drive frequency to a first qubit via a filter to drive the first qubit, wherein the first qubit is electrically connected to a second qubit, wherein the first qubit has a first drive frequency, and wherein the drive frequency is different from the first drive frequency.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 represents a first circuit diagram, according to an example embodiment;

FIG. 2 represents a second circuit diagram, according to an example embodiment;

FIG. 3 represents a third circuit diagram, according to an example embodiment;

FIG. 4 represents a fourth circuit diagram, according to an example embodiment;

Elements of the figures are not necessarily to scale and are not intended to portray specific parameters of the invention. For clarity and ease of illustration, dimensions of elements may be exaggerated. The detailed description should be consulted for accurate dimensions. The drawings are intended to depict only typical embodiments of the invention, and therefore should not be considered as limiting the scope of the invention. In the drawings, like numbering represents like elements.

### DETAILED DESCRIPTION

Exemplary embodiments now will be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will convey the scope of this disclosure to those skilled in the art. In the description, details of well-known features and techniques may be omitted to avoid unnecessarily obscuring the presented embodiments.

For purposes of the description hereinafter, terms such as “upper”, “lower”, “right”, “left”, “vertical”, “horizontal”, “top”, “bottom”, and derivatives thereof shall relate to the disclosed structures and methods, as oriented in the drawing figures. Terms such as “above”, “overlying”, “atop”, “on top”, “positioned on” or “positioned atop” mean that a first element, such as a first structure, is present on a second element, such as a second structure, wherein intervening elements, such as an interface structure may be present between the first element and the second element. The term “direct contact” means that a first element, such as a first structure, and a second element, such as a second structure, are connected without any intermediary conducting, insulating or semiconductor layers at the interface of the two elements. As used herein, the term “same” when used for comparing values of a measurement, characteristic, parameter, etc., such as “the same width,” means nominally identical, such as within industry accepted tolerances for the measurement, characteristic, parameter, etc., unless the context indicates a different meaning. As used herein, the terms “about,” “approximately,” “significantly, or similar terms, when used to modify physical or temporal values, such as length, time, temperature, quantity, electrical characteristics, superconducting characteristics, etc., or when such values are stated without such modifiers, means nominally equal to the specified value in recognition of variations to the values that can occur during typical handling, processing, and measurement procedures. These terms are intended to include the degree of error associated with measurement of the physical or temporal value based upon the equipment available at the time of filing the application, or a value within accepted engineering tolerances of the stated value. For example, the term “about” or similar can include a range of ±8% or 5%, or 2% of a given value. In one aspect, the term “about” or similar means within 10% of the specified numerical value. In another aspect, the term “about” or similar means within 5% of the specified numerical value. Yet, in another aspect, the term “about” or similar means within 10, 9, 8, 7, 6, 5, 4, 3, 2, or 1% of the specified numerical value. In another aspect, these terms mean within industry accepted tolerances.

For the clarity of the description, and without implying any limitation thereto, illustrative embodiments may be described using simplified diagrams. In an actual fabrication, additional structures that are not shown or described herein, or structures different from those shown and described herein, may be present without departing from the scope of the illustrative embodiments.

Differently patterned portions in the drawings of the example structures, layers, and formations are intended to represent different structures, layers, materials, and formations in the example fabrication, as described herein. A specific shape, location, position, or dimension of a shape depicted herein is not intended to be limiting on the illustrative embodiments unless such a characteristic is expressly described as a feature of an embodiment. The shape, location, position, dimension, or some combination thereof, are chosen only for the clarity of the drawings and the description and may have been exaggerated, minimized, or otherwise changed from actual shape, location, position, or dimension that might be used in actual fabrication to achieve an objective according to the illustrative embodiments.

An embodiment when implemented in an application causes a fabrication process to perform certain steps as described herein. The steps of the fabrication process are depicted in the several figures. Unless such a characteristic is expressly described as a feature of an embodiment, not all steps may be necessary in a particular fabrication process; some fabrication processes may implement the steps in different order, combine certain steps, remove or replace certain steps, or perform some combination of these and other manipulations of steps, without departing the scope of the illustrative embodiments.

The illustrative embodiments are described with respect to certain types of materials, electrical properties, structures, formations, layers orientations, directions, steps, operations, planes, dimensions, numerosity, data processing systems, environments, and components. Unless such a characteristic is expressly described as a feature of an embodiment, any specific descriptions of these and other similar artifacts are not intended to be limiting to the invention; any suitable manifestation of these and other similar artifacts can be selected within the scope of the illustrative embodiments.

The illustrative embodiments are described using specific designs, architectures, layouts, schematics, and tools only as examples and are not limiting to the illustrative embodiments. The illustrative embodiments may be used in conjunction with other comparable or similarly purposed designs, architectures, layouts, schematics, and tools.

For the sake of brevity, conventional techniques related to microelectronic fabrication may or may not be described in detail herein. Moreover, the various tasks and process steps described herein can be incorporated into a more comprehensive procedure or process having additional steps or functionality not described in detail herein. In particular, various steps in the manufacture of microelectronic devices may be well known and so, in the interest of brevity, many conventional steps may only be mentioned briefly or may be omitted entirely without providing the well-known process details.

In the following descriptions, the term length applies to dimensional characteristics along the x-axis.

In the following descriptions, the term width applies to dimensional characteristics along the y-axis.

In the following descriptions, the term thickness applies to dimensional characteristics along the z-axis.

In the interest of not obscuring the presentation of embodiments of the present invention, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is rather focused on the distinctive features or elements of various embodiments of the present invention.

Reference will now be made in detail to the embodiments of the present invention, examples of which are illustrated in the accompanying drawings, wherein like reference numerals refer to like elements throughout. Embodiments of the invention are generally directed to utilizing a drive off-resonant power enhancing filter (DOPE filter), wherein the DOPE filter allows for a first qubit to be driven at a driving frequency of a second qubit.

Different gates require different Rabi rates, sometimes the power required to drive some of these gates are quite large, but it is desirable in cryogenic systems to keep the power applied (in Watts) low. Drive tones are applied through drive ports. Drive ports may include microwave inputs to the device. For the case of Transmon qubits, the drive port is coupled directly to the qubit by a charge line, or indirectly through a readout resonator. Coupling through a readout resonator may provide protection from the qubit decaying out the input port. Qubit decay through the input port is also referred to as Purcell loss.

The power for any given Rabi rate can be reduced by increasing the coupling of a qubit to its drive port. However, increasing coupling will increase Purcell loss. This relationship is governed by the equation 1 below:

$$\vert {Ω}_{r} \vert ≃ \frac{\sqrt{P}}{2 π} \sqrt{\frac{1}{ℏ \vert {κ}_{p} \vert}} \qquad equation 1$$

where P is power, h is the reduced Planck's constant, κₚ is the Purcell loss rate, ω is the qubit angular frequency, and Ω_{f} is the Rabi rate.

To achieve longer qubit coherence times, it is important to keep Purcell loss small. Based on the above relationship, in order to achieve longer coherence times, coupling of the qubit needs to be reduced (i.e. lower κₚ), which would need an increase in drive tone power to achieve an equivalent Rabi rate.

A drive off-resonant power enhancing (DOPE) filter couples the driven qubit strongly to the drive line at the frequency of the detuned intended drive tone. The qubit T1 frequency is unaffected but it becomes easy to drive the qubit at a specific detuned frequency. The DOPE filter is located on the chip thus removing the need to attach off chip filters to the qubits which would typically require the addition of a circulator or isolator to prevent standing waves. This invention is directed to the situation when you have a 1^{st} Qubit (1^{st} Q) connected to a 2^{nd} Qubit (2^{nd} Q), where the drive frequency is different for the 1^{st} Q and the 2^{nd} Q. The present invention allows for driving the 1^{st} Q at the drive frequency of the 2^{nd} Q or some other frequency that is not the drive frequency of the first qubit (the case described here is specific to cross resonance; other gates can use other frequency). A frequency-dependent drive network can allow application of large Rabi rate tones off-resonant from the qubit while still providing Purcell protection on-resonant with the qubit.

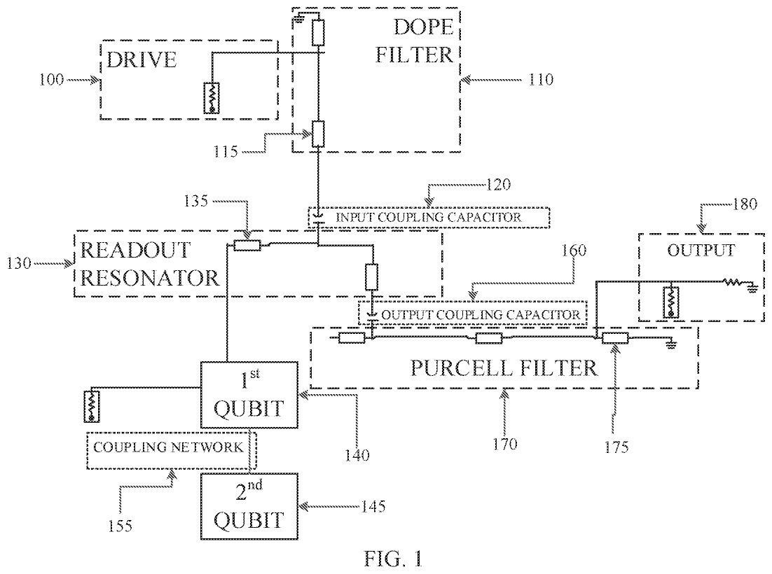

FIG. 1 represents a first circuit diagram, according to an example embodiment. The circuit diagram includes a first qubit 140, a second qubit 145, a coupling network 155, a readout resonator 130, a drive unit 100, a drive off-resonant power enhancing filter (DOPE filter) 110, an input coupling capacitor 120, an output coupling capacitor 160, a Purcell filter 170, and an output unit 180. The circuit diagram is not meant to be limiting as to the design of the circuit, such as, the layout of the components can change, the type of components can change, and/or the number of components can change. The second qubit 145 is connected to the first qubit 140 via a coupling network 155. The first qubit 145 is connected to a readout resonator 130. The read resonator 130 includes at least one resistor 135. A drive unit 100 is connected to the DOPE filter 110. The DOPE filter 110 includes a plurality of STUB filters 115 connected in series. The DOPE filter 110 is connected to an input coupling capacitor 120. The input coupling capacitor 120 is connected to the readout resonator 130. The input coupling capacitor 120 is a T capacitor, such that, the input coupling capacitor is directly connected to the readout resonator 130. An output of the readout resonator 130 is connected to an output coupling capacitor 160. The output coupling capacitor 160 is connected to the Purcell filter 140, where the Purcell filter 140 includes a plurality of resistors 175. The output of the Purcell filter 170 is connected to an output unit 180.

The first qubit 140 has a first drive frequency and the second qubit 145 has a second drive frequency. The first drive frequency and the second drive frequency are different from each other. The DOPE filter 110 allows for driving of the first qubit 140 at the second drive frequency or some other frequency that is not the first drive frequency.

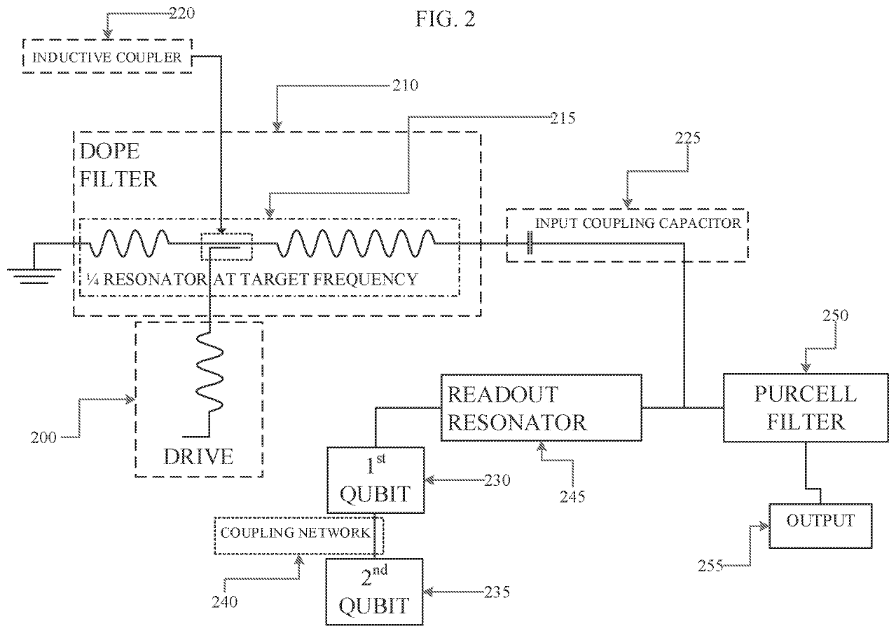

FIG. 2 represents a second circuit diagram, according to an example embodiment. The circuit diagram includes a first qubit 230, a second qubit 235, a coupling network 240, a readout resonator 245, a drive unit 200, a drive off-resonant power enhancing filter (DOPE filter) 210, an input coupling capacitor 225, a Purcell filter 250, and an output unit 255. The drive 200 is connected to the DOPE filter 210 via an inductive coupler 220. The DOPE filter includes a ¼ wave resonator 215, where the ¼ wave resonator 215 is set at a target drive frequency. The target drive frequency is the desired drive frequency for the first qubit 230. The second qubit 235 is connected to the first qubit 230 via a coupling network 240. The first qubit 230 is connected to a readout resonator 245. The DOPE filter 210 is connected to the output of the readout resonator 245 via an input coupling capacitor 225. The input coupling capacitor 225 is a T capacitor. The Purcell filter 250 is connected downstream of the readout resonator 245 and an output unit 255 is connected to the Purcell filter 250.

The first qubit 230 has a first drive frequency and the second qubit 235 has a second drive frequency. The first drive frequency and the second drive frequency are different from each other. The DOPE filter 210 allows for driving of the first qubit 230 at the second drive frequency or some other frequency that is not the first drive frequency. The target frequency of the ¼ wave resonator 215 is equal to the second drive frequency or some other frequency that is not the first drive frequency.

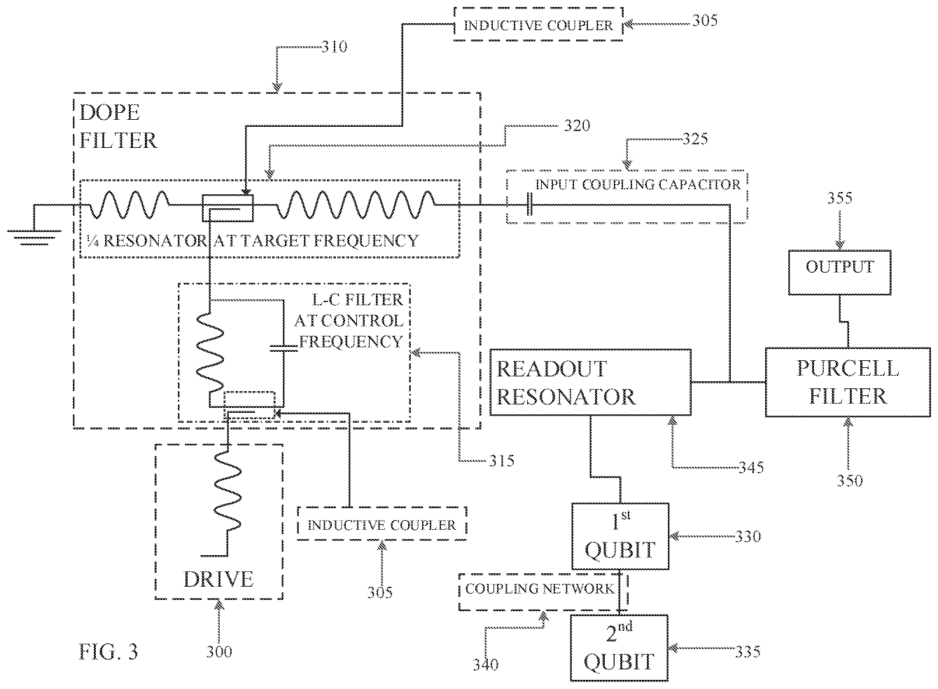

FIG. 3 represents a third circuit diagram, according to an example embodiment. The circuit diagram includes a first qubit 330, a second qubit 335, a coupling network 340, a readout resonator 345, a drive unit 300, a drive off-resonant power enhancing filter (DOPE filter) 310, an input coupling capacitor 325, a Purcell filter 350, and an output unit 355. The DOPE filter 310 includes an L-C filter 315 and a ¼ wave resonator 320. The drive 300 is connected to L-C filter 315 of the DOPE filter 210 via an inductive coupler 305. The L-C filter 315 is connected to the ¼ wave resonator 320 via an inductive coupler 305. The L-C filter 315 is set for a control drive frequency and the ¼ wave resonator 320 is set at a target frequency. The target drive frequency is the desired drive frequency for the first qubit 330. The second qubit 335 is connected to the first qubit 330 via a coupling network 340. The first qubit 330 is connected to a readout resonator 345. The DOPE filter 310 is connected to the output of the readout resonator 345 via an input coupling capacitor 325. The input coupling capacitor 325 is a T capacitor. The Purcell filter 350 is connected downstream of the readout resonator 345 and an output unit 355 is connected to the Purcell filter 350.

The first qubit 330 has a first drive frequency and the second qubit 335 has a second drive frequency. The first drive frequency and the second drive frequency are different. The DOPE filter 310 allows for driving of the first qubit 330 at the second drive frequency or some other frequency that is not the first drive frequency. The target frequency of the ¼ wave resonator 315 is equal to the second drive frequency or some other frequency that is not the first drive frequency. The control frequency for the L-C filter 315 is equal to the first drive frequency for the first qubit 330.

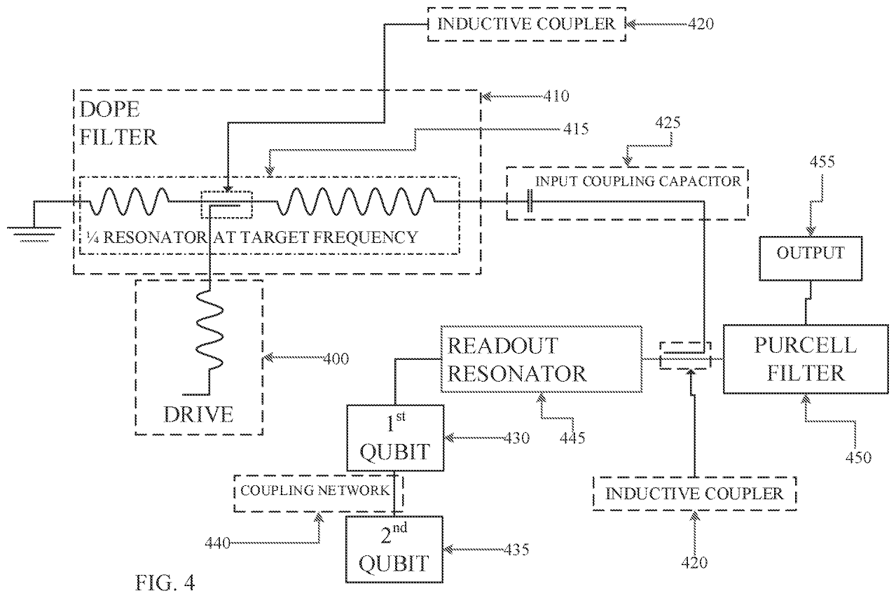

FIG. 4 represents a second circuit diagram, according to an example embodiment. The circuit diagram includes a first qubit 430, a second qubit 435, a coupling network 440, a readout resonator 445, a drive unit 400, a drive off-resonant power enhancing filter (DOPE filter) 410, an input coupling capacitor 425, a Purcell filter 450, and an output unit 455. The drive 400 is connected to the DOPE filter 410 via an inductive coupler 420. The DOPE filter includes a ¼ wave resonator 415, where the ¼ wave resonator 415 is at the target drive frequency. The target drive frequency is the desired drive frequency for the first qubit 430. The second qubit 435 is connected to the first qubit 430 via a coupling network 440. The first qubit 430 is connected to a readout resonator 445. The DOPE filter 410 is connected to an input coupling capacitor 425. The input coupling capacitor 425 is connected to an output of the readout resonator 445 via an inductive coupler 420. The Purcell filter 450 is connected downstream of the readout resonator 445 and an output unit 455 is connected to the Purcell filter 450.

The first qubit 430 has a first drive frequency and the second qubit 435 has a second drive frequency. The first drive frequency and the second drive frequency are different. The DOPE filter 410 allows for driving of the first qubit 430 at the second drive frequency or some other frequency that is not the first drive frequency. The target frequency of the ¼ wave resonator 415 is equal to the second drive frequency or some other frequency that is not the first drive frequency.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. An apparatus comprising:
a first qubit has a first driving frequency;
a second qubit electrically connected to the first qubit, wherein the second qubit has a second driving frequency, wherein the second driving frequency is different than the first driving frequency;
a readout resonator electrically connected to the first qubit and the second qubit;
a filter electrically connected to the readout resonator, wherein the filter allows for the first qubit to be driven at the second driving frequency of the second qubit; and
a drive unit electrically connected to the filter.

2. The apparatus of claim 1, wherein the filter is comprised of a plurality of STUB filters connected in series.

3. The apparatus of claim 1, wherein the filter is comprised of a ¼ wave resonator, wherein the ¼ wave resonator is set a target frequency.

4. The apparatus of claim 3, wherein the target frequency is equal to the second driving frequency.

5. The apparatus of claim 1, wherein the filter includes a L-C filter, wherein the L-C filter is set at a control frequency.

6. The apparatus of claim 1, wherein the control frequency is equal to the first driving frequency.

7. The apparatus of claim 6, wherein the filter further includes a ¼ wave resonator, wherein the ¼ wave resonator is set a target frequency.

8. The apparatus of claim 7, wherein the target frequency is equal to the second driving frequency.

9. An apparatus comprising:
a first qubit has a first driving frequency;
a second qubit electrically connected to the first qubit;
a readout resonator electrically connected to the first qubit and the second qubit;
a filter electrically connected to the readout resonator, wherein the filter allows for the first qubit to be driven at a drive frequency that is different from the first driving frequency; and
a drive unit electrically connected to the filter.

10. The apparatus of claim 9, wherein the filter is comprised of a plurality of STUB filters connected in series.

11. The apparatus of claim 9, wherein the filter is comprised of a ¼ wave resonator, wherein the ¼ wave resonator is set at the drive frequency.

12. The apparatus of claim 9, wherein the filter includes a L-C filter, wherein the L-C filter is set at a control frequency.

13. The apparatus of claim 12, wherein the control frequency is equal to the first driving frequency.

14. The apparatus of claim 13, wherein the filter further includes a ¼ wave resonator, wherein the ¼ wave resonator is set at the drive frequency.

15. A method comprising:
applying a drive frequency to a first qubit via a filter to drive the first qubit, wherein the first qubit is electrically connected to a second qubit, wherein the first qubit has a first drive frequency, and wherein the drive frequency is different from the first drive frequency.

16. The method of claim 15, wherein the second qubit has a second drive frequency, and wherein the drive frequency is equal to the second drive frequency.

17. The method of claim 15, wherein the filter is comprised of a plurality of STUB filters connected in series.

18. The method of claim 15, wherein the filter is comprised of a ¼ wave resonator, wherein the ¼ wave resonator is set at the drive frequency.

19. The method of claim 15, wherein the filter includes a L-C filter, wherein the L-C filter is set at a control frequency.

20. The method of claim 19, wherein the control frequency is equal to the first driving frequency.

21. The method of claim 20, wherein the filter further includes a ¼ wave resonator, wherein the ¼ wave resonator is set at the drive frequency.
